(19) United States
(12) Patent Application Publication
(10) Pub. No.: US 2011/0075896 A1
(43) Pub. Date: Mar. 31, 2011

(54) COMPUTER READABLE MEDIUM, SYSTEMS AND METHODS FOR MEDICAL IMAGE ANALYSIS USING MOTION INFORMATION

(76) Inventor: Kazuhiko MATSUMOTO, Tokyo (JP)

(21) Appl. No.: 12/567,577

(22) Filed: Sep. 25, 2009

(51) Int. Cl. G06K 9/00

(52) U.S. Cl. 382/128

(57) ABSTRACT

Motion information generated by comparing one or more clinical volume data may be used in a variety of applications. Examples of applications described herein include 1) generation of interpolated volume data at a time point somewhere between two received instance of volume data; 2) propagation of geometric information from one instance of volume data to another based on the motion information; and 3) adjustment of volume data to fix one or more features at a same location in a series of rendered instances of volume data. Combinations of these effects may also be implemented.

### TECHNICAL FIELD

The invention relates generally to medical image visualization techniques, and more particularly, to the use of motion analysis in the visualization of volume data.

### BACKGROUND OF THE INVENTION

A variety of medical devices may be used to generate clinical images, including computed tomography (CT) and magnetic resonance imaging (MRI) scanners. These scanners may generate images of human anatomy. Repeated scans may vary due to changes in the subject's posture, a change in the subject's condition, natural functioning of the imaged anatomy, or other reasons.

Motion analysis techniques exist for correlating features in two images. The motion analysis techniques may identify spatial transformation between images, and may generate a displacement vector for each pixel of the image.

Some video systems leverage motion analysis information to smooth playback capability. A video sequence usually contains a set of images sampled with a fixed time interval. The spatial transformation may be used to insert an image between two regularly spaced video frames that may improve the smoothness of playback.

While motion analysis techniques have been used to interpolate between regularly sampled video frames, motion analysis techniques have not been widely exploited in the clinical setting.

### BRIEF DESCRIPTION OF THE DRAWINGS

FIG. 1 is a schematic illustration of a system in accordance with an embodiment of the invention.

FIG. 2 is a schematic illustration of two heart images representing volume data processed to yield motion information.

FIG. 3 is a schematic illustration of a system including executable instructions for generating interpolated volume data in accordance with an embodiment of the invention.

FIG. 4 is a flowchart illustrating a method of generating interpolated volume data according to an embodiment of the present invention.

FIG. 5 is a schematic illustration of interpolated volume data generated at a time point between the time points of the images of FIG. 2 in accordance with an embodiment of the invention.

FIG. 6 is a schematic illustration of a series of images representing volume data that include an image based on interpolated volume data in accordance with an embodiment of the present invention.

FIG. 7 is a schematic illustration of a system including executable instructions for geometry propagation in accordance with an embodiment of the present invention.

FIG. 8 is a flowchart illustrating the propagation of geometry information utilizing motion information in accordance with an embodiment of the present invention.

FIG. 9 is a schematic illustration of an example of the use of motion information to propagate geometry in accordance with an embodiment of the present invention.

FIG. 10 is a schematic illustration of a system including executable instructions for geometry propagation in accordance with an embodiment of the present invention.

FIG. 11 is a flowchart illustrating an example of rendering one or more three-dimensional images based on motion information in accordance with an embodiment of the present invention.

FIG. 12 is a schematic illustration of images based on volume data where a target location has been fixed in accordance with an embodiment of the present invention.

FIG. 13 is a schematic illustration of rendered volume data in accordance with an embodiment of the present invention.

### DETAILED DESCRIPTION

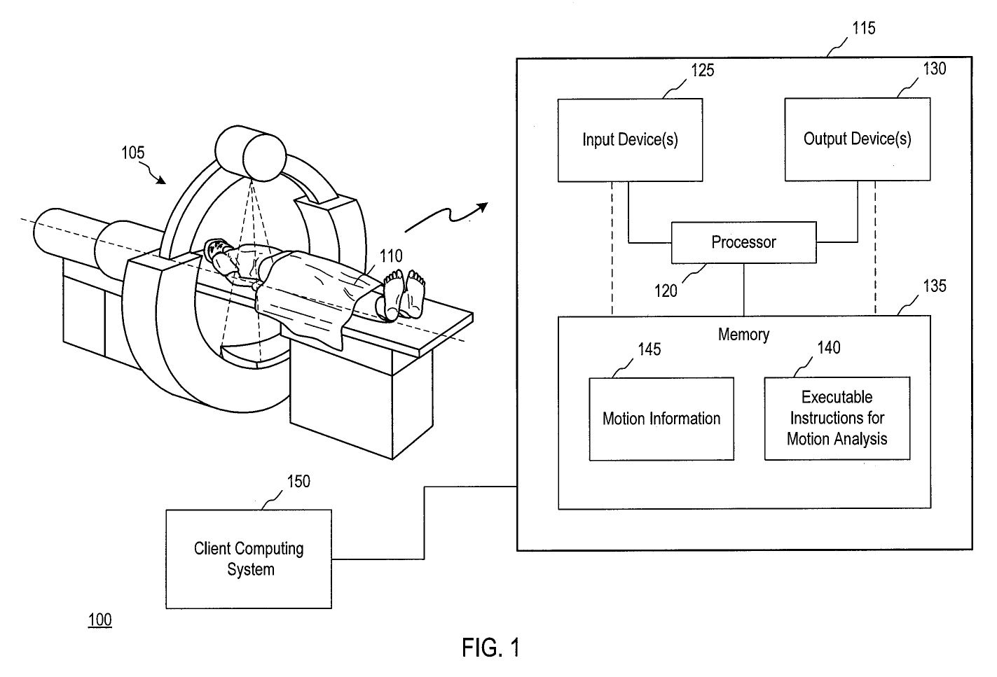

FIG. 1 is a schematic illustration of a medical scenario 100 in accordance with an embodiment of the invention. A computed tomography (CT) scanner 105 is shown and may collect data from a subject 110. The data may be transmitted to an imaging system 115 for processing. The imaging system 115 may include a processor 120, input devices 125, output devices 130, a memory 135, or combinations thereof. As will be described further below, the memory 135 may store executable instructions for performing motion analysis 140. Following the processing of volume data using motion analysis, motion information 145 may be stored in the memory 135. The motion information 145 may be used in a variety of ways, as will be described further below, to generate or alter volume data that may be visualized on one or more of the output devices 130 or transmitted for display by a client computing system 150. The client computing system 150 may communicate with the imaging system 115 through any mechanism, wired or wireless.

Embodiments of the present invention are generally directed to processing of volume data. Volume data as used herein generally refers to three-dimensional image obtained from a medical scanner, such as a CT scanner, an MRI scanner, or an ultrasound. Data from multiple scans that may occur at different times may be referred to as different instances of volume data. Other scanners may also be used. Three-dimensional images or other visualizations may be rendered or otherwise generated using the volume data. The visualizations may represent three-dimensional information from all or a portion of the scanned region.

Any of a variety of input devices 125 and output devices 130 may be used, including but not limited to displays, keyboards, mice, network interconnects, wired or wireless interfaces, printers, video terminals, and storage devices.

Although shown encoded on the same memory 135, the motion information 145 and the executable instructions for motion analysis 140 may be provided on separate memory devices, which may or may not be co-located. Any type of memory may be used.

Although a CT scanner 105 is shown, data according to embodiments of the present invention may be obtained from a subject using any type of medical device suitable to generate volume data, including an MRI scanner or an ultrasound scanner.

It is to be understood that the arrangement of computing components and the location of those components is quite flexible. In one example, the imaging system 115 may be located in a same facility as the medical scanner acquiring data to be sent to the imaging system 115, and a user such as a physician may interact directly with the imaging system 115 to process and display clinical images. In another example, the imaging system 115 may be remote from the medical scanner, and data acquired with the scanner sent to the imaging system 115 for processing. The data may be stored locally first, for example at the client computing system 150. A user may interface with the imaging system 115 using the client computing system 150 to transmit data, provide input parameters for motion analysis, request image analysis, or receive or view processed data. In such an example, the client computing system 150 need not have sufficient processing power to conduct the motion analysis operations described below. The client computing system may send data to a remote imaging system 115 with sufficient processing power to complete the analysis. The client computing system 150 may then receive or access the results of the analysis performed by the imaging system 115, such as the motion information. The imaging system 115 in any configuration may receive data from multiple scanners.

Any of a variety of volume data may be manipulated in accordance with embodiments of the present invention, including volume data of human anatomy, including but not limited to, volume data of organs, vessels, or combinations thereof.

Having described a basic configuration of a system according to embodiments of the present invention, motion analysis techniques will now be described. One or more of the motion analysis techniques may be used to generate motion information, and the resulting motion information may be used to generate or alter clinical images in a variety of ways.

Motion analysis techniques applied for volume data generally determine a spatial relationship of features appearing in two or more instances of volume data. A feature may be any anatomical feature or structure, including but not limited to an organ, muscle or bone, or a portion of any such anatomical feature or structure, or a feature may be a point, a grid or any other geometric structure created or identified in a volume data of the patient. In embodiments of the present invention, motion analysis may be performed on a plurality of three-dimensional clinical instances of volume data derived from a subject using a scanner. The instances of volume data may represent scans taken a certain time period apart—such as milliseconds in the case for example of CT scans, such as those used to capture left ventricle motion in a heart, or days or months apart in the case for example of scans to observe temporal changes of lesions or surgical locations. The image processing system 115 of FIG. 1 may perform motion analysis to determine a spatial transformation between multiple instances of volume data. In particular, executable instructions for motion analysis 140 may direct the processor 120 to identify corresponding features in different instances of volume data. This feature correspondence may be used to derive a displacement vector for any number of features in the instances of volume data or all of the features. The displacement vector may represent the movement of a feature shown in the voxel from one instance of volume data to the next. The resulting motion analysis information, which may include a representation of the displacement vector, or another association between corresponding features or voxels in two instances of volume data, may be stored in a memory or other storage device, such as the memory 135 of FIG. 1.

Motion analysis techniques to identify one or more spatial transformations that map points in one image to the corresponding points in another image are known in the art. The spatial transformation may generally be viewed as representing a continuous 3D transformation. Typical techniques may be classified into three categories—landmark based, segmentation based, and intensity based. In landmark based techniques, a set of landmark points may be specified in all volume data instances. For example, a landmark may be manually specified at points of anatomically identifiable locations visible in all volume data instances. A spatial transformation can be deduced by the given landmarks. In segmentation based techniques, segmentation of target objects may be performed prior to the motion analysis process. Typically, the surface of the extracted objects may be deformed so as to estimate the spatial transformation that aligns the surfaces. In intensity based techniques, a cost function that penalizes asymmetry between two images may be used. The cost function may be based on voxel intensity and the motion analysis process may be viewed as a problem to find a best parameter of the assumed spatial transformation to maximize or minimize the returned value. Depending on selection of the cost function and optimizer, a wide variety of methods may be used. Any of these techniques ultimately identify one or more spatial transformations between two or more instances of volume data and motion information may be derived from the spatial transformation, for example by calculating a displacement vector for a voxel. In some examples, a system may be capable of performing motion analysis utilizing multiple techniques, and a user may specify the technique to be used. In some examples, a system may perform motion analysis utilizing multiple techniques, and a user may select a technique that produces desirable results.

The motion information may also be used to provide quantitative information such as organ deformation (distance) in CT scans or velocity changes in ultrasound scans.

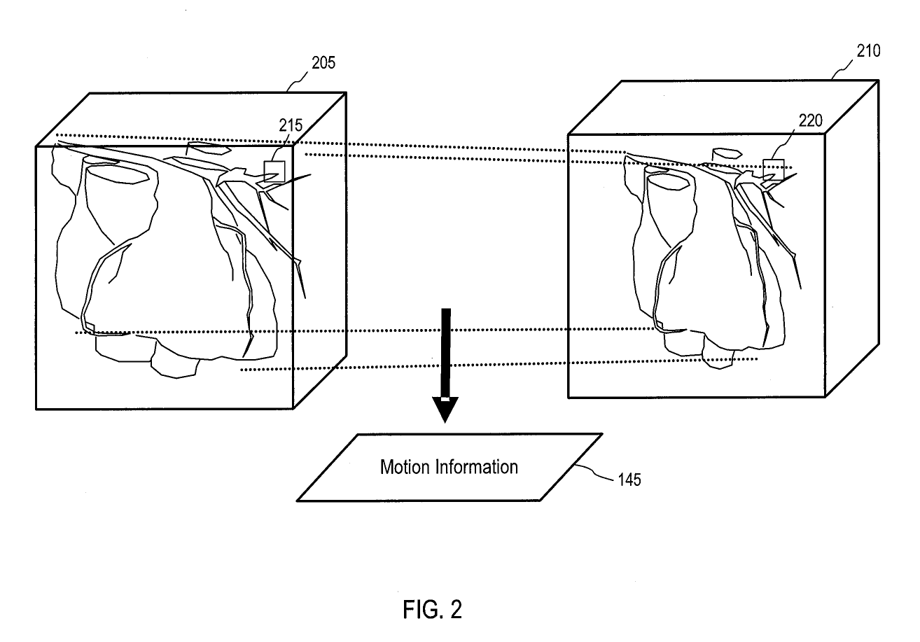

FIG. 2 is a schematic illustration of a first image representing a first instance of volume data 205 and a second image representing a second instance of volume data 210 of a heart. Applying the motion analysis techniques described above, the processor 120 of FIG. 1 may determine a spatial transformation between the points 215 of the first instance of volume data and the points of the second instance of volume data 220. That is, motion analysis identifies where a point shown in a particular feature in the first instance of volume data has moved to in the second instance of volume data. So, for example, if a feature is shown first at point A of the first instance of volume data, and then at point B of the second instance of volume data, the motion information would indicate that feature A and B were corresponding features, and may store a displacement vector representing a distance between the features A and B. This correspondence may be used to generate motion information 145. An association between these points 215 and 220 may accordingly be stored, or a vector representing the motion of the point 215 to the location of the point 220 may be stored, or both. In some examples, the motion information may not be immediately stored, but may be communicated to another processing device, computational process, or client system.

Motion information generated by comparing one or more instances of clinical volume data may be used in a variety of applications that will now be further described. In general, applications include 1) generation of one or more instances of interpolated volume data at a time point somewhere between two received instances of volume data; 2) propagation of geometric information from one instance of volume data to another based on the motion information; and 3) adjustment of volume data to fix one or more features at a same location in a series of visualizations based on the volume data. Combinations of these effects and other effects may also be implemented.

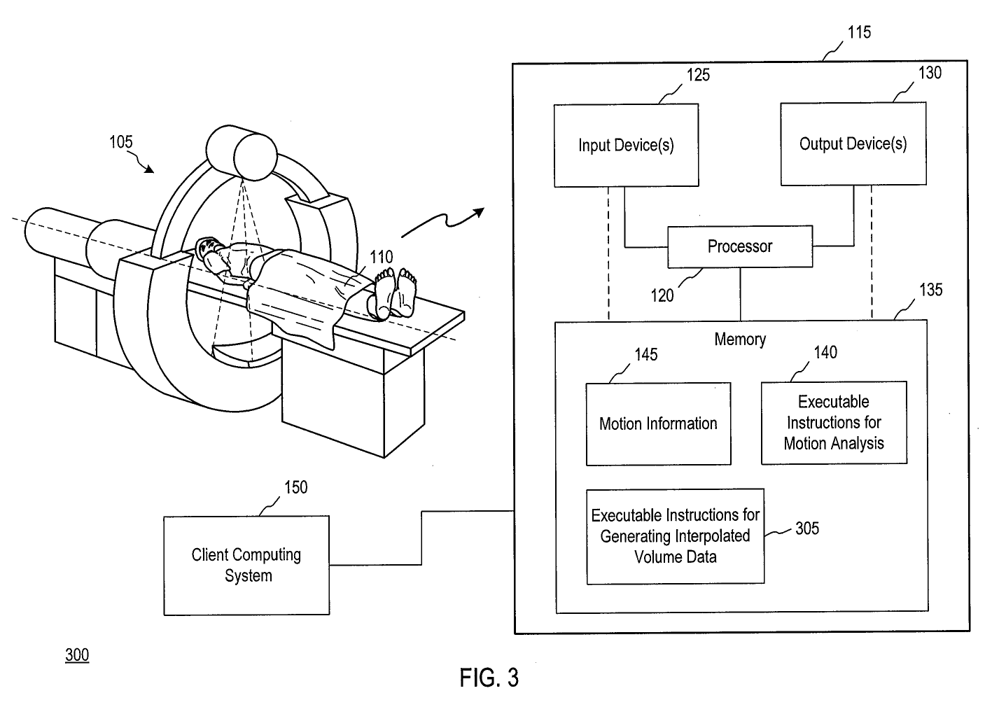

Embodiments of the system and method of the invention may generate interpolated volume data at respective time points between two received instances of volume data. FIG. 3 is a schematic illustration of a medical scenario 300 including the imaging system 115 which includes executable instructions for generating interpolated volume data 305. While shown as encoded in the memory 135, the executable instructions 305 may reside on any computer readable medium accessible to the processor 120, such as for example, external storage devices or memory devices. In other embodiments, the executable instructions 305 may reside on any computer readable medium accessible to the client computing system 150, and may be executed by the client computing system 150.

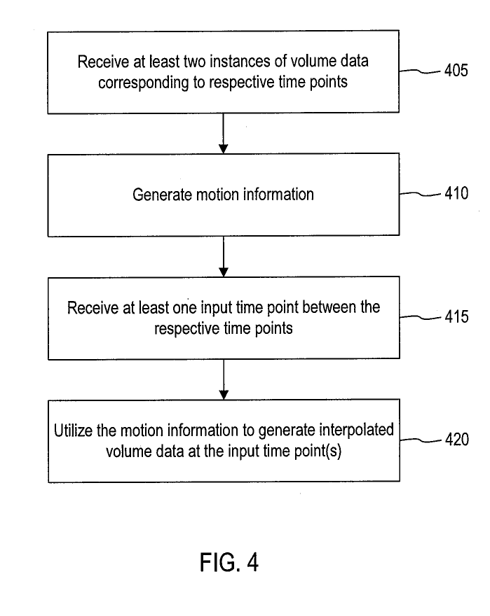

A schematic flowchart for a method to generate interpolated volume data according to an embodiment of system and method of the present invention is shown in FIG. 4. At block 405, at least two instances of volume data may be received corresponding to respective time points. For example, the instances of volume data may have been obtained from a heart scan within milliseconds of one another, or from an organ scan taken weeks, months, or years apart. The received instances of volume data may generally include the same clinical target. In block 410, motion information is generated based on one or more spatial transformations between the instances of volume data, as has been described above, such as the correspondence between the points 215 and 220 in FIG. 2. At least one input time point may be received at block 415 that is between the time points of the received instances of volume data. A user may input the desired intermediate time point, or in other examples, the input time points may be previously stored and accessible to the processor. In block 420, the motion information is used to generate interpolated volume data at the input time points. An unlimited number of instances of interpolated volume data may be generated at arbitrary time points. The time points at which to generate interpolated volume data may be specified by time or percentage of time between the input instances of volume data, or may be specified by a time point at which a condition is met. For example, interpolated volume data may be generated when a target object's physical volume becomes maximum or minimum, or a speed of motion is maximum or minimum.

In one example, a moving organ may be captured in multiple scans and the volume of the moving organ may be measured at each scan. A volume curve may be generated, and a time point where the physical volume of the moving organ becomes maximum may be identified. The time point may be in between the actual scans. Interpolated volume data may be generated at the time point of maximum physical volume of the organ. The interpolated volume data may be referenced and compared with the future scans since the volume data is known to contain the organ at a position of maximum physical volume. This may be particularly useful for following up an organ with abnormal state.

Accordingly, based on the motion information, the processor 120 shown in FIG. 3 may determine that a particular object in an instance of volume data attains a maximum or minimum speed, acceleration, or displacement at a certain time. Interpolated volume data may then be generated at that time. Any of a variety of interpolation techniques may be used to generate the interpolated volume data such as, but not limited to, spatial interpolation (including linear, cubic, and spline interpolation) and voxel intensity interpolation (including linear, cubic, and spline interpolation). In some examples, the interpolation technique used may be specified by a user.

4D volume data filters may also be applied to the volume data and used to generate or affect the interpolated volume data, and may have effects including smoothing, edge enhancement, minimum or maximum intensity projection, intensity difference, intensity accumulation, histogram matching, or combinations thereof.

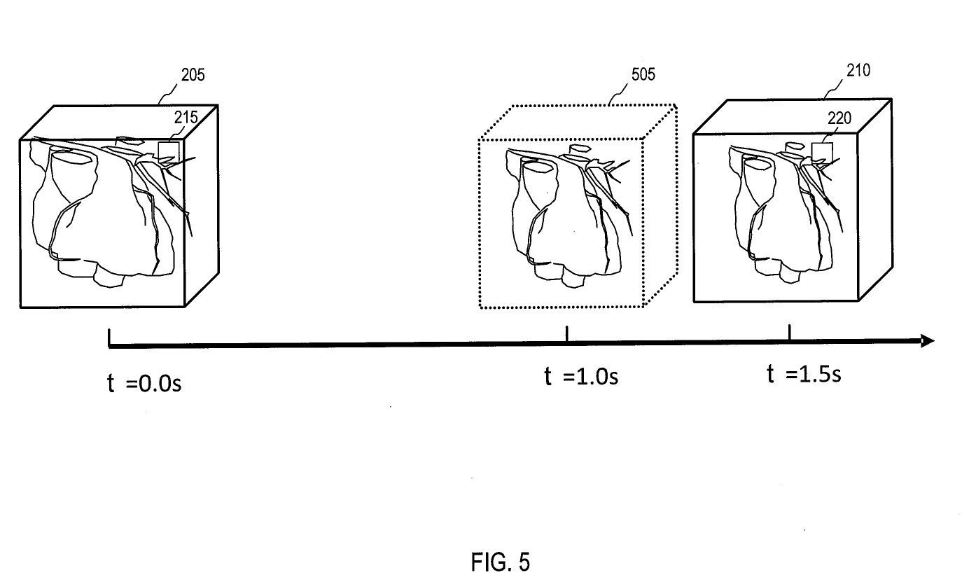

FIG. 5 is a schematic illustration of interpolated volume data 505 generated, for example in accordance with the method of FIG. 4, at a time point between the time points of the first instance of volume data 205 and the second instance of volume data 210 using the motion information 145. It is to be understood that the interpolated volume data 505 may be generated at any time point between the two instances of volume data 205 and 210, and may not be halfway between the instances of volume data, but may instead be at a time point that is specified by a user. In FIG. 5, the volume data 205 corresponds to a time of 0 seconds and the volume data 210 corresponds to a time of 1.5 second. The interpolated volume data 505 is generated to represent the organ at the time of 1 second. So, for example, referring back to FIG. 4, at block 405 the instances of volume data 205 and 210 may be received and motion information generated at block 410. The time point of 1 second may then be received at block 415. The motion information may then be utilized at block 420 to generate the interpolated volume data 505.

The volume data interpolation techniques described herein may be used to produce a set of evenly spaced instances of volume data. For example, in some embodiments, volume data generated by a medical scanner may be obtained at uneven intervals. Viewing a succession of visualizations based on that volume data may therefore not be smooth, with jerks or jumps that may be visible. Embodiments of the present invention may generate interpolated volume data between instances of volume data taken by a scanner such that when a series of visualizations that includes the interpolated volume data is viewed, the succession is smoother.

In one example, a physician orders 10 scans at 2 second intervals following administration of contrast medium, then 10 scans at 5 second intervals. The total of 20 scans are available but their scan intervals are not the same. An arbitrary number of instances of volume data having equal intervals may be obtained in accordance with examples of the invention. This may be useful to reduce a total number of actual scans required, which may result in reducing a radiation dose needed for CT scans, for example by taking scans with shorter intervals only when it is necessary and then generating interpolated volume data with a fixed interval. In follow-up scans, for example, the actual scans are not generally performed with a fixed time interval. By applying examples of the present invention, a series of volume data instances with a fixed interval may be generated. For diagnostic purposes, visualizing the fixed interval volume data may promote better understanding of how fast or slow a legion or tumor grows or shrinks. In cardiac scans, the duration of a heart beat may be slightly different. Suppose that a series of scans are done at basal position of a heart during a heart beat followed by a series of scans at apical position. Even if the same number of scans are available for both locations, since the duration of a heartbeat may be different, the scan interval may not be the same. By applying examples of the present invention, interpolated volume data at the same time points can be obtained. Accordingly, the imaging system 115 of FIG. 3 may generate, for example in accordance with the process of FIG. 4, evenly spaced instances of volume data based on received unevenly spaced instances of volume data.

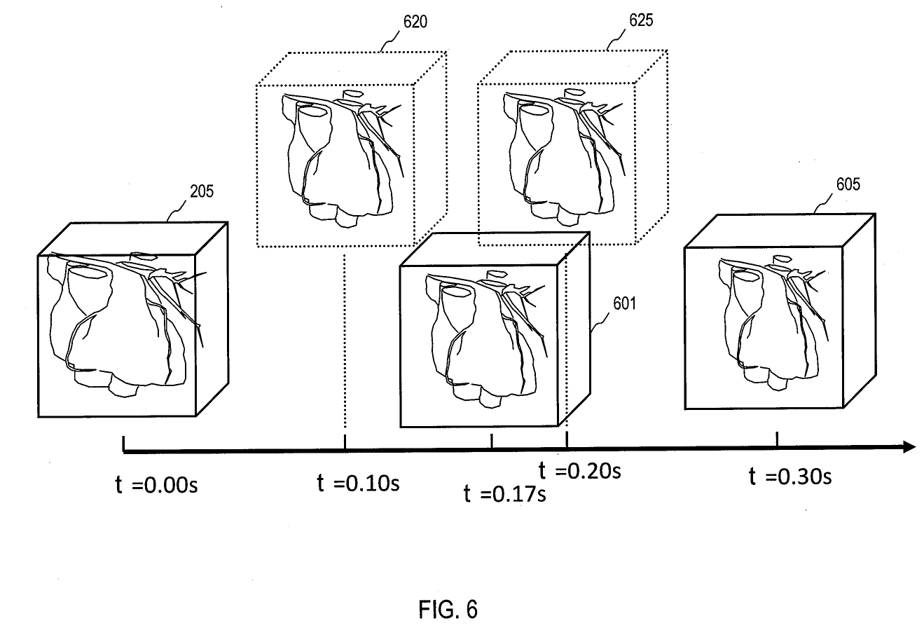

For example, FIG. 6 depicts a first instance of volume data 205, a second instance of volume data 601 and a third instance of volume data 615 taken at times 0 seconds, 0.17 seconds, and 0.3 seconds, respectively, for a medical scanner such as scanner 105. The uneven spacing of the original instances of volume data may result in uneven or jerky playback. The imaging system and method of the present invention may analyze the instances of volume data 205, 601, 615, generate motion information, and based on the motion information, generate interpolated fourth volume data 620 and fifth volume data 625 corresponding to time points 0.1 seconds and 0.2 seconds, respectively. In this manner, an evenly spaced sequence of instances of volume data has been generated that may be used for smooth playback. Although a relatively short time frame of less than a second has been shown, the same technique may be used to generate interpolated volume data at time points on the order of hours, days, months, or years, as would be appropriate for the clinical setting encountered.

Accordingly, using the interpolated volume data, the imaging system 115 or the client computing system 150, or both, of FIG. 3 may playback a 4D movie with an accurate frame rate. To save memory, the interpolated volume data 620 and 625 may be generated on-the-fly, such as when a user requests to view a movie. In addition or instead, the interpolated volume data 620 and 625 may be discarded after they have been provided to a display for rendering or otherwise used for playback. In this manner, the memory requirement for generating the movie may be reduced. Also, an evenly spaced data set may enable comparisons between different volume data instances, such as volume data instances for different subjects or volume data instances taken for a same subject with different time periods between scans. For example, if 10 cardiac scans are performed for a patient within one heartbeat at one time and one year later 20 follow-up scans are performed within the subject's heartbeat, direct comparison of the original 10 scans to the 20 scans taken a year later can be difficult since each scan was performed at a different time point. Interpolation may be used to generate evenly spaced volume data instances and a same number of volume data instances per time interval, enabling direct comparison of the volume data instances.

Interpolated volume data, such as fourth and fifth volume data instances 620 and 625 of FIG. 6, may also be used as input to quantitative analysis to identify a shape or motion of a feature, many of which are known in the art for various clinical applications. Rather than performing the quantitative analysis only on the original volume data, and interpolating the results to arrive at the intermediate time point, the quantitative analysis may be performed directly on the interpolated volume data at the time point. Since the interpolated volume data is generated based on motion information, the resulting quantitative analysis may be preferable to interpolated results.

Examples of the generation of interpolated volume data based on motion information have been described above. It is to be understood that computer software, including a computer readable medium encoded with instructions to perform all or a portion of the above methods may also be provided, as can be computing systems configured to perform the methods, as has been generally described. The systems may be implemented in hardware, software, or combinations thereof.

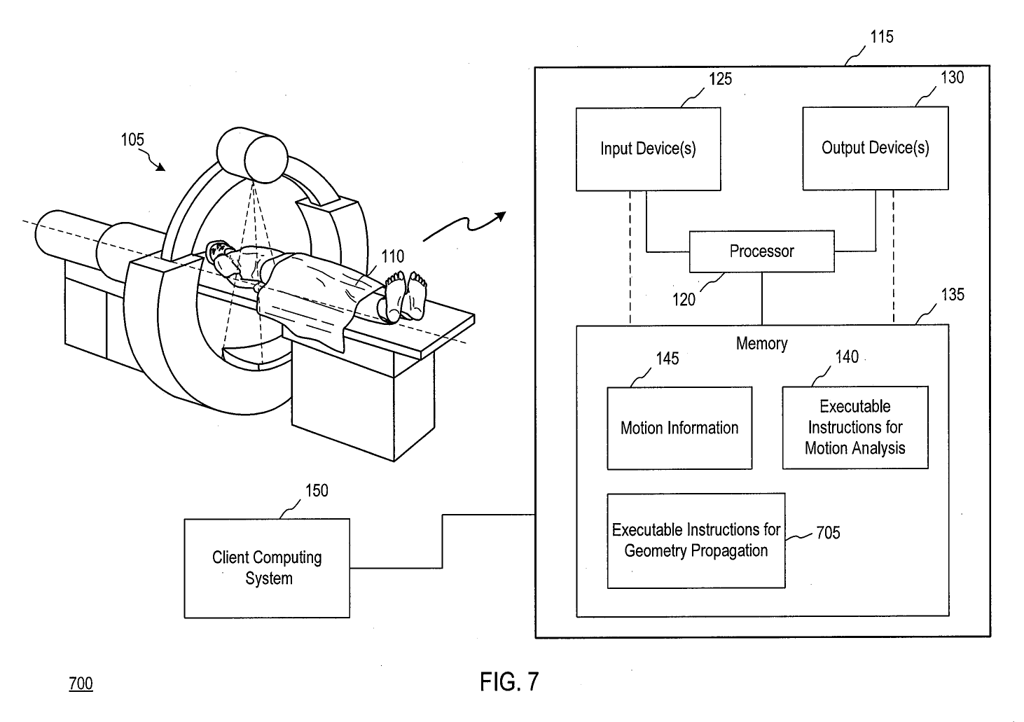

Motion information may also be utilized to propagate geometry information in clinical volume data, as will now be described. Geometry information is associated with objects in a volume. For example, contour of an object, centerline of a vessel, surface of an organ. Geometric information of an object can be defined in a volume, manually or automatically or both. FIG. 7 is a schematic illustration of a medical scenario 700 including the imaging system 115 which includes executable instructions for geometry propagation 705. While shown as encoded in the memory 135, the executable instructions 705 may reside on any computer readable medium accessible to the processor 120.

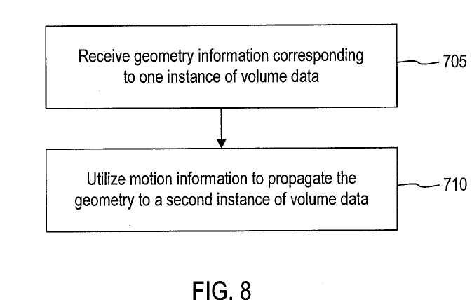

FIG. 8 is a flowchart providing an overview of the propagation of geometry information utilizing the motion information in accordance with a method of the present invention. Referring to block 805 in FIG. 8, geometry information corresponding to an instance of volume data is received. Geometry information may include a line or a shape. For example, geometric information may include a region that may define one or more organs in the volume data, or portions of those organs. Geometry information can also include a line that defines a centerline of a vessel. With reference back to FIG. 7, a user may specify a geometric feature, such as a line or a shape in an instance of volume data. The user may utilize the client computing system 150, or some other system in communication with the imaging system 115, or may use the imaging system 115 directly in this regard. For example, the client computing system 150 may include an input device allowing a user to input the geometric feature. Alternatively or in addition, one of the input devices 125 of the imaging system 115 may be used to input the geometric feature. The geometry information may then be stored at the client computing system 150, imaging system 115, such as in the memory 135, or in other locations. In some examples, the geometry information may be stored along with the volume data with which it corresponds. The geometry information may be retrieved and utilized by any system, including those other than the one on which they were originally specified. The motion analysis to generate motion information may be performed before or after the receipt of geometry information.

Although the executable instructions for performing geometry propagation 705 are shown as part of the imaging system 115 in FIG. 7, in other examples the instructions may be stored at and executed by the client computing system 150. That is, it may require less processing power to propagate geometry information than to generate motion information. Accordingly, in some embodiments, the imaging system 115 may be a remote system configured to generate the motion information and alert one or more client systems 150 when the motion information is available. The client system may receive and store geometry information and propagate the geometry information based on motion information obtained from the imaging system 115. Other computing configurations may also be available.

In block 710 of FIG. 8, the motion information is utilized to propagate the geometry information to a second instance of volume data. The geometry information may be propagated to any number of volume data instances in this manner. To propagate the geometry from a first volume data instance to a second volume data instance, the motion information associated with the points corresponding to the geometry is accessed. Recall that the motion information represents a spatial transformation between two volume data instances. Accordingly, the geometry information may be generated in a second volume data instance at point locations dictated by the motion information.

In one example, ten volume data instances are present containing an organ, and geometric information defining the contours of the organ may be desired in each instance of volume data. A user may only need to draw the contour on a single instance of the volume data and the imaging system may propagate the contour to the other nine instances of volume data based on motion information. This may reduce manual interaction required to generate contours on multiple instances of volume data.

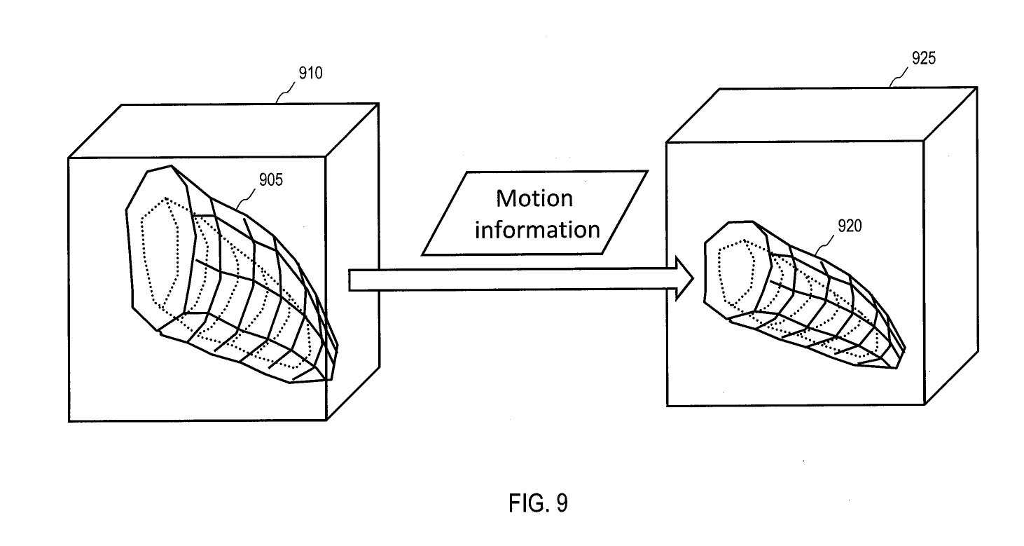

FIG. 9 is a schematic illustration of an example of the use of motion information to propagate geometry in accordance with the system of FIG. 7 and the method of FIG. 8. A contour 905 of a left ventricle may be defined by a user in an instance of volume data 910. The motion information 915 is utilized to generate a corresponding contour 920 in another instance of volume data 925. The propagated geometry may be stored, displayed along with or separate from the corresponding volume data, or combinations thereof.

The propagation of geometry may also be used in combination with the interpolation of volume data described above. That is, geometry may also be propagated and displayed or stored along with interpolated volume data. A single set of motion information may be accessed to generate interpolated volume data and propagated geometry associated with those interpolated volume data.

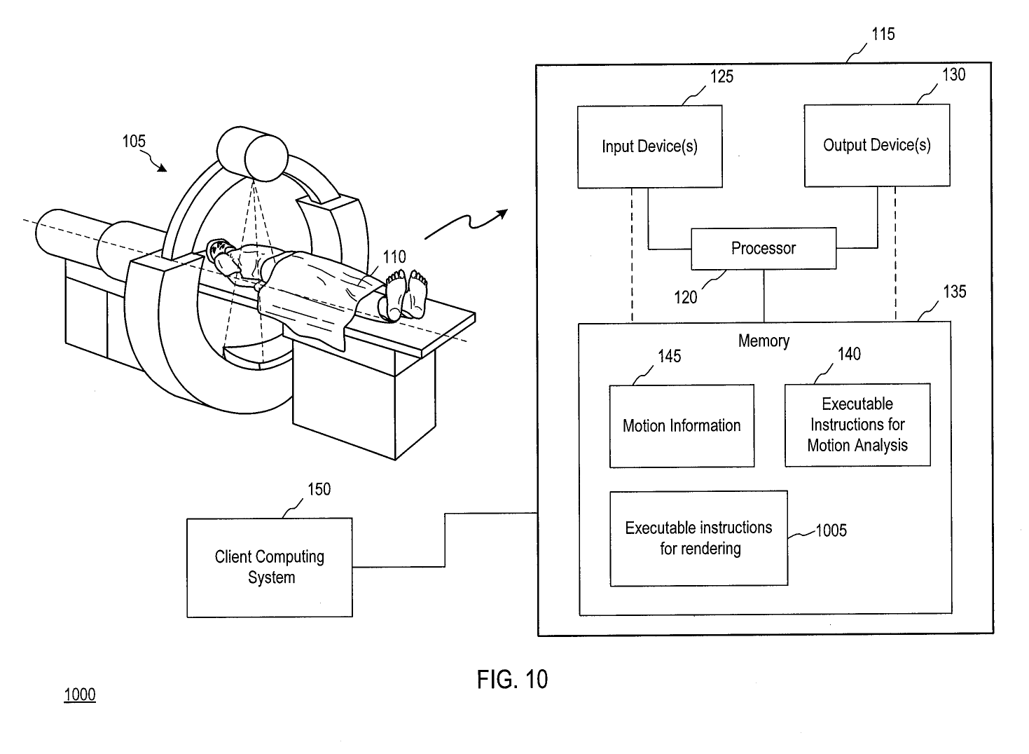

Motion information may also be used to fix a target portion of volume data such that multiple visualizations may be generated having a same view point, orientation, and zoom, for example. In one such embodiment illustrated schematically in FIG. 10, a medical scenario 1000 is provided that includes imaging system 115 having executable instructions for geometry propagation 1005. While shown as encoded in the memory 135, the executable instructions 1005 may reside on any computer readable medium accessible to the processor 120. The executable instructions for rendering 1005 may include instructions for rendering according to any of a variety of known methods including, but not limited to volume rendering (VR), maximum intensity projection (MIP), multi-planar reconstruction (MPR), curved-planar reconstruction (CPR), and virtual endoscopy (VE). Instructions for several rendering methods may be included, and a user may specify a particular type of rendering method, which selection may be based on an organ or other feature of interest. Embodiments of the present invention may utilize motion information to fix a target location over multiple instances of volume data. That is, the executable instructions for rendering 1005 may utilize the motion information to adjust imaging parameters including but not limited to view point, orientation, rotation angle, and zoom, based on the motion information.

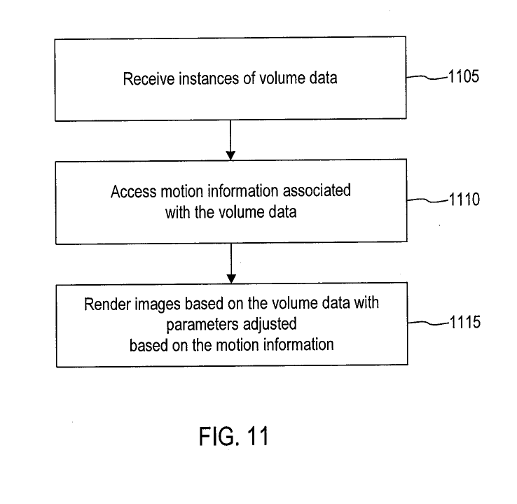

A flowchart illustrating an example of rendering one or more instances of volume data based on motion information, for example with the imaging system 115 of FIG. 10, is shown in FIG. 11. Multiple instances of volume data may be received by the system 115 in block 1105. Following motion analysis, described above, the motion information associated with the volume data is accessed in block 1110 and in block 1115 the volume data is rendered with one or more parameters adjusted based on the motion information.

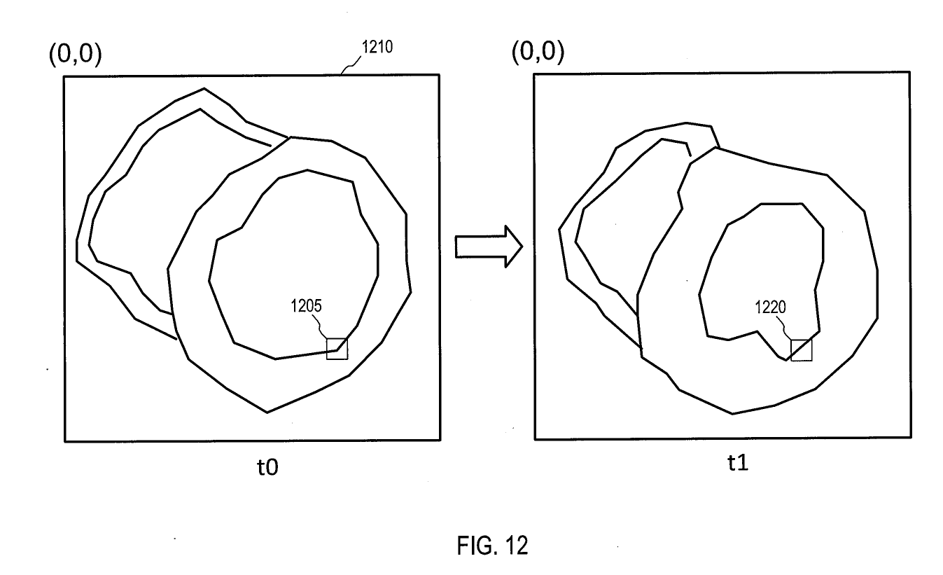

For example, the parameters may be adjusted to fix a particular feature in one or more instances of volume data. That is, a user may identify a target area of an instance of volume data, and a sequence of volume data instances may be rendered such that the target area remains in a fixed location throughout the sequence. FIG. 12 is a schematic illustration of volume data instances where a target location has been fixed. A user may specify a target, such as a location 1205 in a first instance of volume data 1210. Referring back to FIG. 11, the imaging system 115 may render an instance of volume data in block 1115 with one or more parameters adjusted in accordance with the input target. For example, referring back to FIG. 12, a subsequent instance of volume data 1215 may be rendered such that the corresponding target location 1220 appears in the same location in the visualization. Although described as a use to the imaging system 115, in some examples executable instructions for rendering may be executed by the client computing system 150 of FIG. 11.

In another example of use of the system 115 of FIG. 10 and the method of FIG. 11, the parameters may be adjusted to present a same viewpoint across multiple instances of volume data. This may be particularly advantageous in scans taken over a longer period of time where the subsequent scans may have been taken at different angles or zoom levels. The motion information may be used to adjust the visualizations of multiple instances of volume data such that they represent a same viewpoint. This may improve the ability to visually compare the volume data.

In one example, a tumor scanned with a few month interval to follow up its growth may be visualized with the same viewing parameters, which may allow radiologists to compare the tumor size more easily. In clinical settings, an organ's boundary is not always well defined. Therefore, slight viewing parameter differences may lead to different diagnosis.

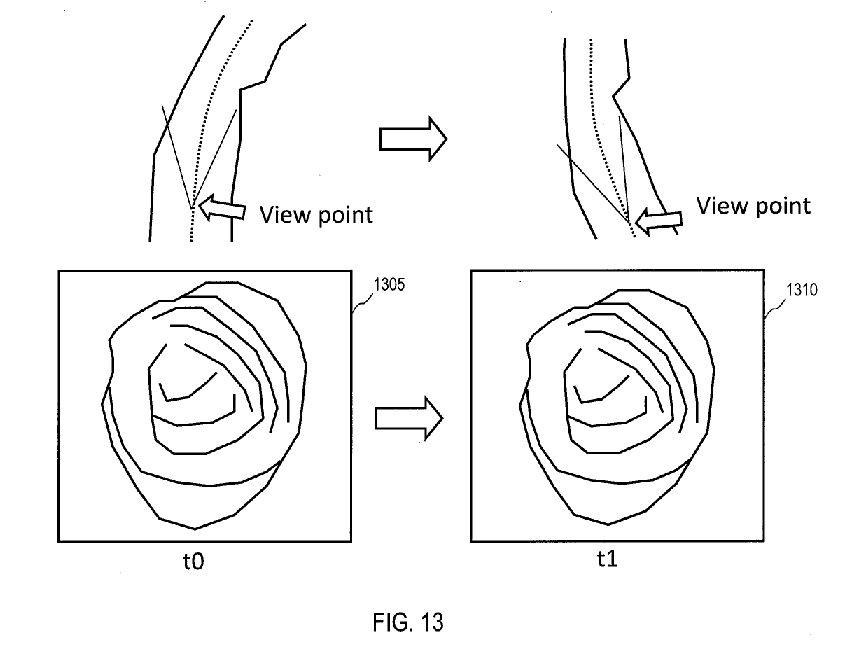

FIG. 13 is a schematic illustration of instances of volume data in VE rendering. The two instances of volume data 1305 and 1310 may have been taken using different viewpoints, but the volume data 1310 may be adjusted such that it is rendered using the same viewpoint as the volume data 1305 based on the motion information.

Examples have been described above of imaging systems that may make use of motion information to interpolate volume data, propagate geometry information, adjust the rendering of volume data, or combinations of those techniques. It will be appreciated that these techniques may be put to a variety of clinical applications, examples of which will now be described.

The motion information obtained and stored based on motion analysis may be used for quantitative analysis. The motion information may correspond to displacement, rotation, deformation, distortion, or combinations thereof. In this manner, the motion information may be used to discern these quantities. As has been generally discussed above, with reference to FIGS. 1 and 2, the motion information may be used to estimate a time point of maximum or minimum displacement, velocity, or acceleration. These quantitative results may be displayed or stored, and may later be used for volume data analysis. In one example, a set of chest volume data may be scanned during a heartbeat. Since the left ventricle and surrounding myocardium will be the major sources of motion in the instances of volume data, the region showing the most motion in the motion information may be identified as corresponding to these anatomical features. In this manner, organ or feature boundaries may be defined based on the motion information.

Interpolation techniques described above may be used to interpolate any number of instances of volume data between two original scanned instances of volume data, for example with the imaging system 115 of FIG. 3 and in accordance with the method of FIG. 4. This may enable smoother playback of the volume data, and may improve comparison to other instances of volume data. This may improve the ability of radiologists to observe possible organ dysfunction over time.

Strain analysis may be conducted automatically in accordance with examples of the present invention. Strain analysis may, for example, enable the evaluation of myocardium motion, for example with the system of FIG. 7 and in accordance with the method of FIG. 8. A grid may be defined on one instance of volume data, and the grid propagated to subsequent instances of volume data utilizing the motion information. Deformation of the grid may be measured and correlated to strain of the anatomy, yielding quantitative strain analysis.

Motion information may also be advantageously used in perfusion studies. In perfusion studies, a contrast agent is generally injected and voxel intensity observed in the resulting volume data. The heart, however, is constantly moving during the scans, and this motion must be compensated for when viewing the time-intensity curve for a point in the volume data. The motion is typically compensated for using CT scans with gating, however gating increases the radiation exposure for the patient. Embodiments of the present invention, for example the system of FIG. 10 in accordance with the method of FIG. 11, may compensate for the heart motion after the scan using motion information. In this manner, a same point, although moving, may be tracked through its point correspondence as reflected in the motion information. This may allow a perfusion study without gating, and therefore lower the radiation dose experienced by a subject.

Embodiments of the present invention may also advantageously be used for adhesion studies. A region defining an organ or other feature may be defined in one instance of volume data and propagated to other instances of volume data using the geometry propagation techniques discussed above. If multiple regions are defined and propagate to other instances of volume data in a manner suggesting they are moving as one region, then the existence of adhesion between the regions may be inferred.

Certain details have been set forth above to provide a sufficient understanding of embodiments of the invention. However, it will be clear to one skilled in the art that embodiments of the invention may be practiced without one or more of these particular details. In some instances, well-known circuits, control signals, timing protocols, and software operations have not been shown in detail in order to avoid unnecessarily obscuring the described embodiments of the invention.

From the foregoing it will be appreciated that, although specific embodiments of the invention have been described herein for purposes of illustration, various modifications may be made without deviating from the spirit and scope of the invention.

What is claimed is:

1. A computer readable medium for use with motion information derived from first and second instances of volume data of the human anatomy and including a representation of a spatial transformation of a feature included in the first and second instances of volume data, the computer readable medium encoded with instructions that when executed cause a processor to receive the first instance of volume data of the human anatomy associated with a first time and the second instance of volume data of the human anatomy associated with a second time, and to use the motion information to create interpolated volume data of the human anatomy at a third time between the first time and the second time.

2. The computer readable medium of claim 1 wherein the instructions further cause the processor to generate the motion information.

3. The computer readable medium of claim 1 wherein the instructions for receiving further include instructions for receiving the first and second instances of volume data generated by a procedure selected from the group consisting of magnetic resonance imaging and computer tomography.

4. The computer readable medium of claim 1 wherein the motion information includes a displacement vector for the feature.

5. The computer readable medium of claim 1 wherein the instructions further include instructions for receiving the third time as input from a user.

6. The computer readable medium of claim 1 wherein the instructions further cause the processor to use the motion information to identify the third time corresponding to a time of one of maximum displacement or minimum displacement of the feature.

7. The computer readable medium of claim 1 wherein the instructions further cause the processor to receive an additional instance of volume data of the human anatomy associated with unevenly-spaced additional time points and create additional interpolated volume data to generate a sequence of volume data instances of the human anatomy at evenly-spaced intervals.

8. The computer readable medium of claim 1 wherein the instructions further cause the processor to visualize the interpolated volume data on a display device.

9. The computer readable medium of claim 1 wherein the instructions further cause the processor to adjust an intensity of at least one voxel in the interpolated volume data based in part on the motion information.

10. The computer readable medium of claim 1 wherein the instructions further cause the processor to use the interpolated volume data to perform quantitative analysis to obtain a shape or quantify a motion of the feature.

11. A computer readable medium for use with motion information derived in part from a first instance of volume data of the human anatomy at a first time and a second instance of volume data of the human anatomy at a second time, the computer readable medium encoded with instructions that when executed cause a processor to receive geometric information associated with a target object in the first instance of volume data, access the motion information and to use the motion information to propagate the geometric information to the second instance of volume data.

12. The computer readable medium of claim 11 wherein the geometric information includes a region defining the target object in the first instance of volume data.

13. The computer readable medium of claim 11 wherein the geometric information includes a line defining a centerline of a vessel in the first instance of volume data.

14. The computer readable medium of claim 11 wherein the geometric information includes a surface defining a cardiac wall in the first instance of volume data.

15. The computer readable medium of claim 11 wherein the instructions further cause the processor to visualize second instance of volume data and the propagated geometric information in an image on a display device.

16. The computer readable medium of claim 11 wherein the first instance of volume data has a viewpoint, and the instructions further cause the processor to access the motion information and use the motion information to propagate the viewpoint to the second instance of volume data, visualize the first instance of volume data with the viewpoint, and visualize the second instance of volume data with the propagated viewpoint.

17. A method for manipulating volume data of the human anatomy, comprising receiving a first instance of volume data of the human anatomy associated with a first time and a second instance of volume data of the human anatomy associated with a second time, employing motion analysis to identify a spatial transformation of a feature included in the first and second instance of volume data and generating motion information with respect to the first and second instances of volume data and using the motion information to create interpolated volume data of the human anatomy at a third time between the first time and the second time.

18. The method of claim 17 wherein the receiving step includes receiving the first and second instances of volume data generated by a procedure selected from the group consisting of magnetic resonance imaging and computer tomography.

19. The method of claim 17 wherein the motion information includes a displacement vector for the feature.

20. The method of claim 17 wherein the third time is a user specified time.

21. The method of claim 17 wherein the method further includes using the motion information to identify the third time corresponding to a time of one of maximum displacement or minimum displacement of the feature.

22. The method of claim 17 further comprising receiving additional instances of volume data of the human anatomy associated with unevenly-spaced additional time points and creating additional interpolated volume data to generate a sequence of instances of volume data of the human anatomy at evenly-spaced intervals.

23. The method of claim 17 further comprising displaying the interpolated volume data on a display device.

24. The method of claim 17 wherein step of using the motion information to create interpolated volume data includes adjusting an intensity of at least one voxel in the interpolated volume data based in part on the motion information.

25. The method of claim 17 wherein the method further includes using the interpolated volume data to perform quantitative analysis to obtain a shape or quantify a motion of the feature.

26. A method for manipulating volume data of the human anatomy, comprising receiving a first instance of volume data of the human anatomy associated with a first time and a second instance of volume data of the human anatomy associated with a second time, employing motion analysis to identify a spatial transformation of a feature included in the first and second instances of volume data and generate motion information with respect to the first and second instances of volume data, receiving geometric information associated with the first instance of volume data and using the motion information to propagate the geometric information to the second instance of volume data.

27. The method of claim 26 wherein the geometric information includes a region defining a feature in the first instance of volume data.

28. The method of claim 26 wherein the geometric information includes a line defining a centerline of a vessel in the first instance of volume data.

29. The method of claim 26 wherein the geometric information includes a surface defining a cardiac wall in the first instance of volume data.

30. The method of claim 26 further comprising visualizing the second instance of volume data and the propagated geometric information in an image on a display device.

31. The method of claim 26 wherein the first instance of volume data has a viewpoint, and the method further comprises propagating the viewpoint to the second instance of volume data based in part on the motion information, visualizing the first instance of volume data with the viewpoint, and visualizing the second instance of volume data with the propagated viewpoint.
